(19) United States
(12) Patent Application Publication
(10) Pub. No.: US 2008/0135296 A1
(43) Pub. Date: Jun. 12, 2008

(54) PROTECTIVE COATINGS FOR DRILL PIPE AND ASSOCIATED METHODS

(76) Inventors: Michael D. Kipp, Highland, UT (US); Michael Ridges, American Fork, UT (US); William McCarville, Salt Lake City, UT (US)

Correspondence Address: THORPE NORTH & WESTERN, LLP., P.O. Box 1219, SANDY, UT, 84091-1219, US

(21) Appl. No.: 11/854,322

(22) Filed: Sep. 12, 2007

Related U.S. Application Data
(60) Provisional application No. 60/844,582, filed on Sep. 13, 2006.

(51) Int. Cl. E21B 41/00; E21B 3/00; F16L 9/14; B05D 3/00

(52) U.S. Cl. 175/57; 175/207; 138/145; 427/388.1

(57) ABSTRACT

A coated drill pipe for use in drilling ground such as in rotary drilling for explorative geophysics and associated methods and systems are disclosed and described. A protective coating can be coated over at least a portion of an exterior or interior surface of the drill pipe. The protective coating can include a polyurea such as an aromatic polyurea, a silicone modified polyurea, or an aluminized polyurea. Drill pipes can be shielded by coating a drill pipe with a polyurea composition such as by spray coating. In connection with suitable systems and coated or uncoated well casings, these coated drill pipes can perform for dramatically extended periods of time over conventional drill pipes.

### RELATED APPLICATIONS

This application claims the benefit of earlier filed U.S. Provisional Patent Application No. 60/844,582, filed Sep. 13, 2006 which is incorporated herein by reference.

### FIELD OF THE INVENTION

The present invention relates generally to drill pipes. More particularly, the present invention is related to methods and associated coatings for rotary drill pipes and the like. Accordingly, the present application involves the fields of geophysics, exploratory drilling, polymer chemistry, and material science.

### BACKGROUND OF THE INVENTION

Natural resources such as petroleum, natural gas, or other valuable materials often require drilling in order to recover and/or identify. In particular, energy resources such as petroleum and natural gas are becoming increasingly difficult to find and recover economically. As such the costs of exploration and recovery efforts continue to rise as well.

Conventional methods of exploration and recovery include rotary drilling using a drill rig with mud injection. Unfortunately, during drilling the mud slurry tends to accumulate debris and other materials which become highly corrosive and erosive to the drill pipe and drill shaft of the drill string. Typically, these drill strings have a useful life on the order of several work days up to two months before failure occurs and/or replacement becomes necessary. Thus, drill pipes present very unique challenges over conventional transport pipes, sewage pipe, or other pipe. In particular, the mud slurry generally contains bentonite, various clays, polymer additives, scavengers, pH control additives, thickeners, as well as debris removed from the drilled area such as minerals, rock, toxic gases, etc. which mix to form potentially highly corrosive liquids/gases and other toxic fluids depending on the nature of the formation being drilled.

Several efforts have been made to increase the useful life of these pipes. These include internally coated epoxy-phenolic resins, externally coated tar paper, and the like. Although these coatings can be beneficial, improvement in useful life has been limited. Further, more recently, efforts have focused on controlling the pH and other properties of the mud slurry in order to reduce its corrosiveness. For example, various additives such as pH control agents, buffer solutions, chelating agents, and the like have been used to increase useful life of the drill pipes.

However, these and other approaches still suffer from drawbacks such as limited lifespan, excessive cost, delamination, pin-holes, toxic effluent, among others. As such, pipe and drilling solutions which are suitable for use in practical applications continue to be sought through ongoing research and development efforts.

### SUMMARY OF THE INVENTION

Accordingly, the present invention provides a coated drill pipe for use in drilling ground such as in rotary drilling for explorative geophysics. A protective coating can be coated over at least a portion of an exterior surface of the drill pipe. The protective coating can include a polyurea such as an aromatic polyurea, a silicone modified polyurea, or an aluminized polyurea.

In accordance with one additional aspect of the present invention, a geophysical exploration drill system can include a coated drill pipe as above. Further, a well retaining casing can be oriented in the ground concentrically about at least a portion of the coated drill pipe. Generally, the well retaining casing and coated drill pipe can be oriented substantially vertically, i.e. parallel to gravity, and concentrically oriented with the drill pipe inside the well retaining casing. A mud source can also be configured to supply mud to the drill bit during rotation thereof. Mud can flow through the interior of the drill pipe toward the drill bit. Removal of the mud can be accomplished via flow through an annular space between the coated drill pipe and the well retaining casing.

The coated drill pipes of the present invention can be shielded by coating exposed external working surfaces of a drill pipe with a polyurea composition to form a coated drill pipe having a protective coating thereon. Coating can be accomplished by spray coating, dip coating, or other suitable coating methods, although spray coating is particularly effective.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWING

FIG. 1 is a schematic of a coated drill pipe incorporated into a rotary drilling system shown in part in accordance with one embodiment of the present invention.

The drawing will be described further in connection with the following detailed description. Further, this drawing is not necessarily to scale and is by way of illustration only such that dimensions and geometries can vary from those illustrated.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a bit” includes one or more of such components, reference to “a coating” includes reference to one or more of such materials, and reference to “a spray technique” includes reference to one or more of such techniques.

### DEFINITIONS

In describing and claiming the present invention, the following terminology will be used in accordance with the definitions set forth below.

As used herein, “metallic” refers to a metal, or an alloy of two or more metals. A wide variety of metallic materials are known to those skilled in the art, such as iron, steel, stainless steel, titanium, tungsten, aluminum, copper, chromium, etc., including alloys and compounds thereof.

As used herein, “adjacent” refers to near or close sufficient to achieve a desired affect. Although direct physical contact is most common and preferred in the layers of the present invention, adjacent can broadly allow for spaced apart features.

As used herein, “elongation at breaking” refers to the percentage increase in dimension at which the material fails, ruptures, or otherwise breaks. For example, a 1 foot length of polyurea which stretches to 4 feet before breaking would have a 300% elongation to breaking, i.e. [(4−1)/1]×100.

As used herein, “rotational flexure” refers to flexing of a tube or pipe about the circumference of the pipe along the axial length of the pipe. As an illustration, a straight line along the side of the pipe in the absence of any mechanical stress will become helical as rotational forces are applied producing rotational flexure. Due to the lengths involved, typical pipes can experience up to several rotations per 1000 feet without permanent deformation or damage to the pipe.

As used herein, “working” when used with a time frame refers to operational time. For example, a drill pipe system which is in service for 12 hours a day for one week has a working time of 0.5 weeks.

As used herein, “substantial” and “substantially”, when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein. Further, the term “about” also includes the exact numerical limit as if such were explicitly recited.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 micron to about 5 microns” should be interpreted to include not only the explicitly recited values of about 1 micron to about 5 microns, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

The Invention

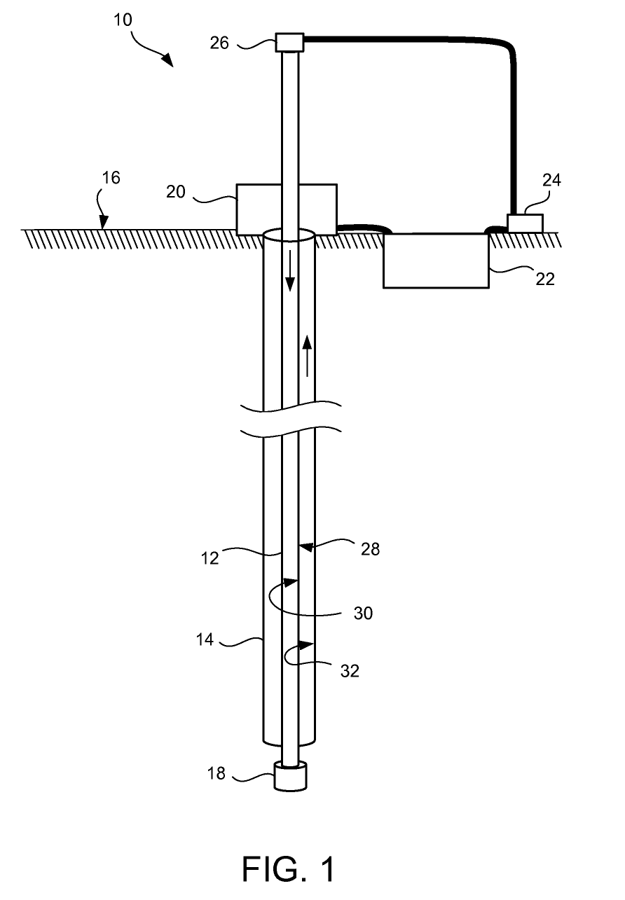

FIG. 1 illustrates a geophysical exploration drill system 10 which can include a coated drill pipe 12. A well retaining casing 14 can be oriented in the ground 16 concentrically about at least a portion of the coated drill pipe. The drill pipe can include a drill bit 18 attached to a lower end of the coated drill pipe. During rotation of the drill pipe and drill bit a mud source can be configured to supply mud to the drill bit to provide lubrication and a fluid medium for removal of rock and other debris from the well. The mud can be introduced via the interior of the drill pipe and removed via the annular space between the coated drill pipe and the well retaining casing. As mud is returned toward the top of the well it is collected in a well cap area 20 and then sent to a mud return 22 for filtering and/or testing. A pump 24 can be used to return the filtered mud to the drill pipe via an injection head 26. Other features of the system are not illustrated or discussed in detail, but can also be included such as, but not limited to, support derrick, turntable for rotating the pipe, winches, mud filters, mud make-up lines, and the like.

In accordance with the present invention, the coated drill pipe 12 can include a pipe configured for use in drilling ground 16 and having a protective coating over at least a portion of an exterior surface 28 and optionally over interior surfaces 30 thereof. In one embodiment, the protective coating can substantially cover the entire exterior surface of the pipe. Further, exterior surfaces of the drill pipe which are exposed to drilling mud during use can be coated with the polyurea composition. Alternatively, or in addition, a protective lining can substantially cover the entire interior surface of the pipe. Specifically, in most circumstances the exterior surface will encounter more highly corrosive and abrasive fluid due to the high content of debris contained therein. The debris can range from abrasive rock particles, leached chemicals, minerals, or other compounds to hydrocarbon or gaseous products. All of these materials can present highly abrasive and chemically corrosive conditions to the exterior surfaces of the drill pipe and other system components.

The protective coating can include a polyurea. Polyureas which are particularly suitable can include, but are not limited to, aromatic polyurea, silicone modified polyurea, aluminized polyurea, and combinations thereof. Commercially available polyureas include Evercoat polyureas such as Evercoat 900, Evercoat 905, and Evercoat SPF (BaySystems North America) and modified polyureas such as the EF and EP series and those including the Reactamine technology, e.g. EF SP, EP EF, Extra Blast, Extra Tough, etc. (available from Engineered Polymers International).

In yet another alternative aspect of the invention, the polyurea composition can further include a silicate dispersed therein. Silicates such as potash or other similar materials can increase the abrasion and corrosion resistance of the coating. As a general guideline, the silicate can comprise from about 1 wt % to about 20 wt % of the polyurea composition, although other amounts can be useful.

The polyurea composition used in the present invention can include polyureas such as those listed above with optional additives such as, but not limited to, filler, surface modifiers, colorants, abrasion resistance particulates, antimicrobials, other non-polyurea polymers, and the like. Filler materials can be used to extend the coating coverage of the composition as long as required mechanical and chemical resistance properties of the coating are maintained. Often filler materials can also act as abrasion resistant particulates by improving hardness, toughness or other resistance to mechanical abrasion. Colorants can be useful for a variety of reasons such as, but not limited to, identification of coating failures, color coding for age/pipe type/etc., and identification of manufacturer. Polyureas are typically colorless to only slightly colored, e.g. a faint yellow to brown color. Providing a color within the coating composition can make inspection and replacement or repair much quicker and easier. Anitmicrobials can be readily incorporated into the coating composition by adding antimicrobial materials such as, but not limited to, heavy metal ions, silver ions, benzoates, quaternary aluminum compounds, and the like. Non-polyurea polymers can also be added in relatively small amounts in order to modify the properties of the coating composition for a particular installation or application of drill pipe. For example, a softer rock formation may allow for use of some epoxies, polyurethanes, polyesters, or the like to be added as secondary polymers to the polyurea.

These optional additives can be used singly or in various combinations. For example, abrasion resistant particulates (e.g. potash, graphite, etc.) and a colorant (e.g. for improved identification of coating failures) can be included in the polyurea with or without a secondary polymer such as an epoxy. However, as a general rule, the polyurea can comprise at least 60% by weight of the composition, and in some cases the polymer portion of the polyurea composition can consist essentially of polyureas. In another embodiment, the polyurea composition can consist essentially of polyureas.

In connection with the present invention, the drill pipe can thus be shielded by coating the drill pipe with the polyurea composition to form a coated drill pipe having a protective coating thereon. The step of coating can include spraying the polyurea composition directly on the drill pipe, although coating can also be accomplished by dip coating, brushing, or other suitable coating methods. Often the sprayed polyurea composition requires curing by either application of heat and/or time lapse after mixing a two part composition. Although additional care should be taken, polyureas having a cure or gel time of less than about 3 seconds can be very useful. In some cases, the polyurea may gel in less than about 5 seconds, followed by tack-free curing within about 2 minutes depending on the specific formulation. Spray coating of such quick curing polyurea can be accomplished using a proportioning pump or other suitable device.

In addition, the polyurea coatings of the present invention exhibit desirable performance which is particularly evident during drilling operations. For example, during drilling the drill pipe may flex up to one complete rotation per 1000 feet in rotational flexure. Despite the extended length over which this rotational flexure is distributed, conventional coatings tend to delaminate during flexing and repeated flexing and relaxation, as well as flexure changes due to changes in drill speed. The protective coatings of the present invention can thus be sufficiently flexible to allow at least one rotation of the pipe per 1000 feet of rotational flexure without delamination or damage to the protective coating throughout the useful life of the pipe. Factors which contribute to this performance include, but are not limited to, elongation at breaking, interfacial strength, peel strength, elastic deformation relaxation, and the like. In one specific aspect of the invention, the protective coating can have an elongation at breaking of from about 300% to about 900%.

Further, the protective coatings of the present invention are highly resistant to corrosion (e.g. chemical breakdown at the surface) and erosion (e.g. mechanical abrasion breakdown at the surface). This resistance to damage is the result of both chemical and mechanical properties of the polyurea compositions, as well as the configuration or surface morphology of the cured coating. In particular, many coating materials suffer from pinholes which provide passage of fluids toward the underlying surface. In contrast, the polyurea compositions of the present invention, with appropriate coating procedures, can be readily formed that are substantially continuous and substantially free of pinholes.

As a general guideline, the coatings of the present invention can have a thickness from about 0.03 inches to about 0.10 inches, and in some cases from about 0.04 inches to about 0.06 inches such as about 0.05 inches. However, other coating thicknesses may be suitable. Coating thickness less than about 0.02 inches can be mechanically weak and prone to failure due to abrasion or damaging contact with other materials, e.g. chains, pipe wrenches, pipe turntable, winches, etc., while coating thicknesses greater than about 0.2 to 0.25 inches can result in excessive waste of polymer material, reduced toughness, and internal stresses from uneven curing times across the thickness of the coating.

The underlying drill pipe can be formed of any suitable material which has the mechanical strength necessary for rotational drilling. Suitable materials can include, but are not limited to, stainless steel, iron, and combinations or alloys thereof. Currently preferred pipe material can include steel.

Most often, the coated drill pipe is used in applications where the drill depth ranges from several hundred meters to several thousand meters. Therefore, the drill pipe can be configured for end-to-end attachment of multiple smaller drill pipe segments to form a drill string of a desired length. In such cases, the junction between two adjoining drill pipes can be further protected by a second coating of the polyurea composition. These secondary coatings can be formed by spraying or brushing the uncured polyurea composition onto the seams between joined drill pipes. Generally the seams and immediately adjacent polyurea coating can be cleaned, roughened, and/or otherwise prepared to provide a secure bond with the secondary coating.

In accordance with one aspect of the present invention, the protective coating can be sufficiently flexible to allow at least one rotation of the pipe per 1000 feet of rotational flexure without delamination or damage to the protective coating. It is most often desirable that the polyurea coating has sufficient adhesion to the pipe surface to prevent initial delamination and to retard additional delamination in the event of damage to a small area of the coating. The adhesion can be improved by providing a textured surface of the pipe or a pretreatment which aids in bonding the polyurea to the metal pipe. Texturing can be accomplished, for example, by sanding, etching, or the like.

Referring again to FIG. 1 the well retaining casing 14 can be formed of a material which is has sufficient mechanical strength to prevent collapse of the well and corrosion resistance sufficient to withstand the expected well lifetime. Most often the well retaining casing can be formed of steel, although other materials such as, but not limited to, concrete or a polymer can also be suitable. For example, a steel casing can be cemented in place using concrete. In addition, the interior surface 32 of the well retaining casing can be coated with a polymer such as the polyurea compositions used on the drill pipe 12.

The coated drill pipes of the present invention are particularly suitable for use in rotary drilling for wells and exploration geophysics. A portion of ground can be contacted with an attached drill bit under rotary motion. In accordance with the present invention, the coated drill pipes can withstand contact and use over a period of time from about 1 working month to about 14 working months, although other times can be obtained depending on the specific conditions. For example, aggressive drilling of hard rock formations can reduce the useful life whereas soft formations can allow extended drilling times. As a general guideline, however, the coated drill pipes of the present invention can perform from about three to a hundred times longer than conventional epoxy coated pipes.

While the following examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

### EXAMPLE

A six inch diameter steel pipe (½″ thickness and 3 feet in length) was obtained from a drilling operation and used as-is without further treatment. A high pressure proportioning pump (available from Grayco Gusmer as Model H2O/35) with a GX8 Pro gun sprayer was loaded with Evercoat 900 polyurea. The steel pipe was then sprayed along the entire exterior surface with the polyurea to a coating thickness of about 0.05 inches with a gel time about 5 seconds.

A conventional drill mud (including debris) was circulated past the coated drill pipe under conditions similar to drilling operations, e.g. about 200 rpm for a period of 700 working hours. No detectable change in appearance of the coating could be detected in terms of coloration, surface marring, or delamination.

The coated drill pipe was then subsequently exposed to a brine solution for a period of another 700 working hours. As before, there was no detectable change in appearance of the coating could be detected in terms of coloration, surface marring, or delamination. A polyurea coating of Evercoat 900 was also exposed to battery acid (sulfuric acid) for a period of about 7 working months. As before, there was no detectable change in appearance of the coating could be detected in terms of coloration, surface marring, or delamination.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A coated drill pipe, comprising a pipe configured for use in drilling ground and having a protective coating over at least a portion of an exterior surface thereof, said protective coating including a polyurea.

2. The coated drill pipe of claim 1, wherein the polyurea is selected from the group consisting of an aromatic polyurea, a silicone modified polyurea, an aluminized polyurea, and composites or combinations thereof.

3. The coated drill pipe of claim 1, wherein the polyurea further includes a silicate dispersed therein.

4. The coated drill pipe of claim 1, wherein the protective coating consists essentially of the polyurea.

5. The coated drill pipe of claim 1, wherein the pipe is a steel pipe.

6. The coated drill pipe of claim 1, wherein the protective coating covers substantially an entire exterior surface of the pipe.

7. The coated drill pipe of claim 1, further comprising a protective lining which substantially covers an entire interior surface of the pipe, said protective lining including a polyurea.

8. The coated drill pipe of claim 1, wherein the drill pipe is configured as a drill string comprising multiple pipes attached end-to-end.

9. The coated drill pipe of claim 1, wherein the drill pipe is configured for use in rotary drilling and further comprises a drill bit secured to one end thereof.

10. The coated drill pipe of claim 1, wherein the protective coating is sufficiently flexible to allow at least one rotation of the pipe per 1000 feet of rotational flexure without delamination or damage to the protective coating.

11. The coated drill pipe of claim 1, wherein the protective coating has an elongation at breaking of from about 300% to about 900%.

12. The coated drill pipe of claim 1, wherein the protective coating is substantially continuous and substantially free of pinholes.

13. The coated drill pipe of claim 1, wherein the protective coating has a thickness from about 0.03 to about 0.10 inches.

14. A method of using the drill pipe of claim 9, comprising contacting a portion of ground with the drill bit under rotary motion.

15. The method of claim 14, wherein the step of contacting extends over a period of time from about 4 working months to about 14 working months, wherein the protective coating exhibits substantially no delamination and substantially no corrosion during the period of time.

16. A geophysical exploration drill system comprising:
a) a coated drill pipe as in claim 9;
b) a well retaining casing oriented in the ground concentrically about at least a portion of the coated drill pipe; and
c) a mud source configured to supply mud to the drill bit during rotation thereof via an interior of the drill pipe and removal of the mud via an annular space between the coated drill pipe and the well retaining casing.

17. The system of claim 16, wherein the polyurea is selected from the group consisting of aromatic polyurea, silicone modified polyurea, aluminized polyurea, and composites or combinations thereof.

18. The system of claim 16, wherein the protective coating consists essentially of the polyurea and is substantially continuous and substantially free of pinholes.

19. The system of claim 16, wherein the protective coating has an elongation to breaking of from about 300% to about 900%.

20. A method of shielding a drill pipe, comprising the steps of:
a) coating an exposed working surface of a drill pipe with a polyurea composition to form a coated drill pipe having a protective coating thereon, said exposed working surface being substantially all exterior pipe surface exposed to drilling mud during use.

21. The method of claim 20, wherein the step of coating includes spraying the polyurea composition on the drill pipe using a proportioning pump.

22. The method of claim 20, wherein the step of coating further includes curing the polyurea composition within 5 seconds of contact with the exposed working surface and wherein the protective coating is substantially free of pinholes.

23. The method of claim 20, wherein the polyurea composition is selected from the group consisting of aromatic polyurea, silicone modified polyurea, aluminized polyurea, silicate dispersed polyurea, and composites or combinations thereof.

24. The method of claim 23, wherein the polyurea composition is a silicate dispersed polyurea, wherein the silicate comprises from about 1 wt % to about 20 wt % of the polyurea composition.

25. The method of claim 20, wherein the protective coating is sufficiently flexible to allow at least one rotation of the pipe per 1000 feet of rotational flexure without delamination or damage to the protective coating, and has an elongation to breaking of from about 300% to about 900%.
